(19) United States
(12) Patent Application Publication
(10) Pub. No.: US 2002/0141357 A1
(43) Pub. Date: Oct. 3, 2002

(54) Method for providing packet call service in radio telecommunication system

(75) Inventors: Do-Jun Park, Seoul (KR); Young-Ky Kim, Seoul (KR); Sung-Hoon Yoon, Seoul (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., KYUNGKI-DO (KR)

(21) Appl. No.: 10/017,554

(22) Filed: Dec. 14, 2001

(30) Foreign Application Priority Data
Feb. 1, 2001 (KR) 04766/2001

(51) Int. Cl. H04Q 7/00

(52) U.S. Cl. 370/328; 370/349

(57) ABSTRACT

A method of providing a diversity of call services in a CDMA-2000 mobile communication system supporting a packet-based call service. The method provides a user with such a packet call service via an Internet Protocol (IP) based network and includes the steps of constructing a set of service primitive information including radio channel assignment information in accordance with at least one service class for the packet call service, determining a service primitive combination according to the service class of the packet call based on the service primitive information, assigning to the mobile terminal a radio channel corresponding to the service primitive combination, if a packet call for at least one mobile terminal is generated, and then providing the mobile terminal with the requested packet call service by using the assigned radio channel.

### PRIORITY OF PRIORITY

This application makes reference to, incorporates the same herein, and claims all benefits accruing under 35 U.S.C. §119 from an application entitled Method For Providing Packet Call Service In Radio Telecommunication System earlier filed in the Korean Industrial Property Office on Feb. 1, 2001 and assigned Serial No. 04766/2001.

### BACKGROUND OF THE INVENTION

1. Field of the Invention

The present invention relates generally to a radio telecommunication system, and in particular, to a method for providing a packet-based interactive call service and a high-quality packet voice call service.

2. Description of the Related Art

In general, a cellular mobile communication system service area is divided into a plurality of BS (Base Station) areas, known as “cells”, which are small service areas. The system controls the base stations using a mobile switching center (MSC) on a centralized control basis, so that a subscriber can maintain a call even while traveling between cells.

A brief description will be made regarding a voice call performed in a common mobile communication system. A mobile terminal (or mobile phone) encodes a user's voice using a Q-CELP (Qualcomm-Code Excited Linear Prediction) EVRC (Enhanced Variable Rate Codec) and transmits the coded voice data to a base station. The base station then converts (or transcodes) the coded voice data received from the mobile terminal into a PCM (Pulse Code Modulation) signal and provides the PCM signal to a mobile switching center. The mobile switching center then transmits the PCM-modulated voice signal to the other party's mobile terminal. That is, for the voice call, the mobile communication system provides a circuit-based call service, in which a radio traffic channel is established between the calling subscriber and the called subscriber to exchange voice signals over the traffic channel.

With the development of communication technology, efforts have been made to combine an IP network with a wireless communication network. A CDMA-2000 (Code Division Multiple Access-2000) system is one of the systems capable of connecting the two networks. The CDMA-2000 system packetizes a voice signal received from a wireless communication network into voice packets and transmits the voice packets to an IP network, so that an IP terminal, assigned its unique IP address, can eventually receive the voice packets. Such a packet-based voice service utilizes an Internet protocol and is referred to as “Voice over Internet Protocol (VoIP)”.

The conventional packet-based voice service is disadvantageous in that call setup time is relatively long because a communication link is required to be set up through both the mobile communication network and the IP network. To resolve this problem, a “multicast” function of the IP network has often been utilized to provide an interactive call service such as a “group call” and a “private” call. Here, the “interactive call service” refers to a call service in which a call is processed through interaction between users: for example, a “Push-to-Talk” function operable in a walkie-talkie is a typical example of the interactive call service. The group call refers to point-to-multipoint communication (or call) among many users in a predetermined group of users, and the private call refers to point-to-point (or one-to-one) communication between two selected users in a predetermined group of users.

However, the conventional mobile communication system strictly standardizes air (or radio) channels used for the voice call so as to provide only the circuit-based call service. The conventional mobile communication system does not support the radio multicast on the physical layer, so that the mobile terminal cannot be provided with various interactive voice call services. In addition, the voice call service provided by the conventional mobile communication system requires a constant occupation of specific air channels on the physical layer, resulting in a waste of the channel resources.

### SUMMARY OF THE INVENTION

It is, therefore, an object of the present invention to provide a method for enabling a CDMA mobile communication system supporting a packet-based call service to provide a diversity of call services.

It is another object of the present invention to provide a method for providing an improved interactive call service and a high-quality voice call service by constructing primitives, as defined herein below, according to various call services and applying radio channels on a physical layer thereto.

The foregoing and other objects of the present invention are achieved by a method of providing a packet call service via an Internet Protocol (IP) based network in a CDMA mobile communication system, preferably including the steps of: constructing a set of service primitive information including radio channel assignment information in accordance with at least one service class for the packet call service; determining a service primitive combination according to the service class of the packet call referring to the constructed service primitive information, if a packet call for at least one mobile terminal is generated; assigning to the at least one mobile terminal a radio channel corresponding to the determined service primitive combination; and providing the at least one mobile terminal with the packet call service by using the assigned radio channel.

According to another aspect of the present invention, a method of providing a packet call service via an Internet Protocol (IP) based network in a CDMA wireless mobile communication system, preferably includes the steps of: upon request of a packet call to an IP network, transmitting service class information of the packet call to a base station in the wireless mobile communication from the IP network; if as a result of analyzing the service class information in the base station, the packet call is an interactive group call serving a half-duplex communication, then determining a service primitive combination corresponding to the group call referring to service primitive information constructed in advance; assigning to a plurality of mobile terminals for the group call a given forward channel “F-CCCH” or “F-BCCH” and a reverse channel “R-CCCH” according to the determined service primitive combination; and providing said plurality of mobile terminals with the interactive group call service by using the assigned radio channels.

### BRIEF DESCRIPTION OF THE DRAWINGS

The above and other objects, features and advantages of the present invention will become more apparent from the following detailed description when taken in conjunction with the accompanying drawings in which:

FIG. 1 is a schematic diagram showing a configuration of a CDMA-2000 system to which the present invention is applicable;

FIG. 2 is a table showing a format of service primitive information stored in a base station according to an embodiment of the present invention;

FIG. 3 is a flowchart illustrating a procedure for providing a packet call service according to an embodiment of the present invention;

FIG. 4 is a diagram illustrating a call process flow for a group call type 2 or a private call type 1 according to one embodiment of the present invention; and

FIG. 5 is a diagram illustrating a call process flow for a group call type 1 or a private call type 2 according to another embodiment of the present invention.

### DETAILED DESCRIPTION OF THE PREFERRED EMBODIMENTS

Preferred embodiments of the present invention will be described hereinbelow with reference to the accompanying drawings, wherein the same components of the invention are indicated in the same reference numerals or symbols. In the following description, well-known functions or constructions are not described in detail since they would obscure the invention in unnecessary detail.

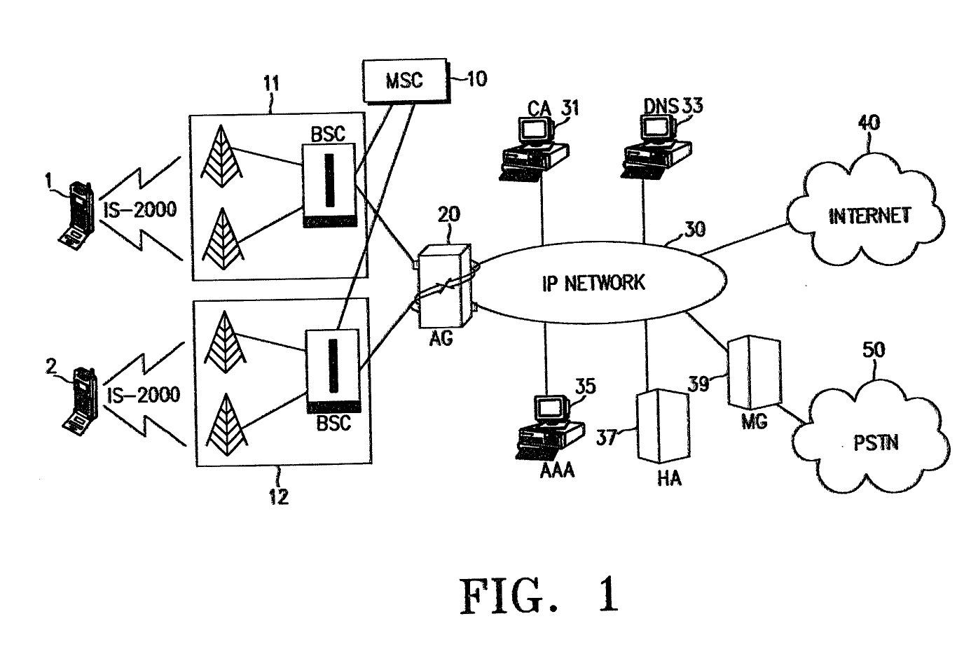

FIG. 1 illustrates a configuration of a CDMA-2000 system to which the present invention is applicable. Referring to FIG. 1, mobile terminals (MTs) 1 and 2 are wirelessly connected to their associated base stations (BSs) 11 and 12, respectively, through radio channels prescribed in the CDMA-2000 standard, for a desired call service. The base stations 11 and 12 each may include a base transceiver subsystem (BTS) and a base station controller (BSC). A mobile switching center (MSC) 10 serves to connect the base stations 11 and 12 to another subscriber system such as a public switched telephone network (PSTN) 50, thereby to provide the mobile terminals 1 and 2 with a circuit-based call service. The base stations 11 and 12, and the mobile terminals 1 and 2 constitute a public land mobile network (PLMN) defined in the CDMA-2000 standard.

Now, a description will be made regarding the structures of physical channels (i.e., radio channels) in the CDMA-2000 mobile communication to which the present invention is applied. Herein, “R-” is prefixed to reverse channels transmitted from the mobile terminal to the base station, while “F-” is prefixed to forward channels transmitted from the base station to the mobile terminal. Also, the following terms are used herein. -PCH (Pilot Channel) is a reference channel for sync acquisition and channel estimation. This channel is a forward channel used for identifying the base stations.

-FCH (Fundamental Channel) is provided to secure reverse compatibility with the conventional IS-95 mobile communication system, and used in transmitting traffic data and signaling information as in the conventional IS-95 standard. This channel is divided into a forward fundamental channel F-FCH and a reverse fundamental channel R-FCH.

-CCCH (Common Control Channel) is used when the base station exchanges control messages with a plurality of mobile terminals within its cell area. This channel is also divided into a forward common control channel F-CCCH and a reverse common control channel R-CCCH.

-BCCH (Broadcasting Control Channel) is a forward channel used for simultaneously transmitting the same message to a plurality of the mobile terminals within its cell area.

-DCCH (Dedicated Control Channel) is exclusively assigned to each mobile terminal for an exchange of control messages with the base station. This channel is also divided into a forward dedicated control channel F-DCCH and a reverse dedicated control channel R-DCCH.

-CPCCH (Common Power Control Channel) is a forward channel used when the base station controls transmission power of the radio channels connected to the mobile terminals within its cell area.

The base stations 11 and 12 are connected to a data core network, i.e., IP network 30 via an access gateway (AG) 20. The access gateway 20 assigns unique IP addresses to the mobile terminals 1 and 2, generates and analyzes IP packets, so that the mobiles terminals 1 and 2 can operate as IP terminals in the IP network. Preferably, the access gateway 20 is included in the mobile switching center 10.

The IP network 30 usually provides the mobile terminals with a packet call service, unlike a general Internet 40 that includes a multiplicity of Internet service providers and nodes. To this end, the IP network 30 is connectable with a plurality of network components including, for example, a call agent (CA) 31, a domain name server (DNS) 33, an authentification, authorization and accounting computer (AAA) 35, a home agent (HA) 37 and a media gateway (MG) 39.

Among the above network components, the call agent 31 manages and controls a packet call session, in particular, controls signaling and routing for a given packet call with a set of signaling and message routing information for interactive calls such as the group call and the private call. The call agent 31 also transmits to the base stations 11 and 12 service class information of the packet call selected by the user, and the base stations 11 and 12 then assign radio channels depending on the packet call information. More detailed explanation of the call agent 31 and the base stations 11 and 12 will be given hereinbelow.

The mobile terminals 1 and 2 can make use of radio channels according to a service primitive set. In particular, the mobile terminals 1 and 2 have the so-called “Push-to-Talk” function so as to be provided with the interactive call service such as the group call and private call according to the present invention. As is known, the “Push-to-Talk” function enables a user to speak to another party over the phone by simply depressing a predetermined button, thereby speeding up a call setup process.

Now, prior to making a detailed description of the operation of the packet call service according to the present invention, some of wordings and their concepts particularly, but not exclusively, used throughout the application will be defined as follows. The term “service primitive” is defined as a set of the quality and type of a call service and the available radio channel according to various service classes, and the service primitive information is stored in a database in the base station, particularly, in a base station controller. The service classes may be changed or further added as required by the users. The base station stores the service primitives in association with the service classes in response to a command from a service provider, and provides a packet call service with reference to the stored information.

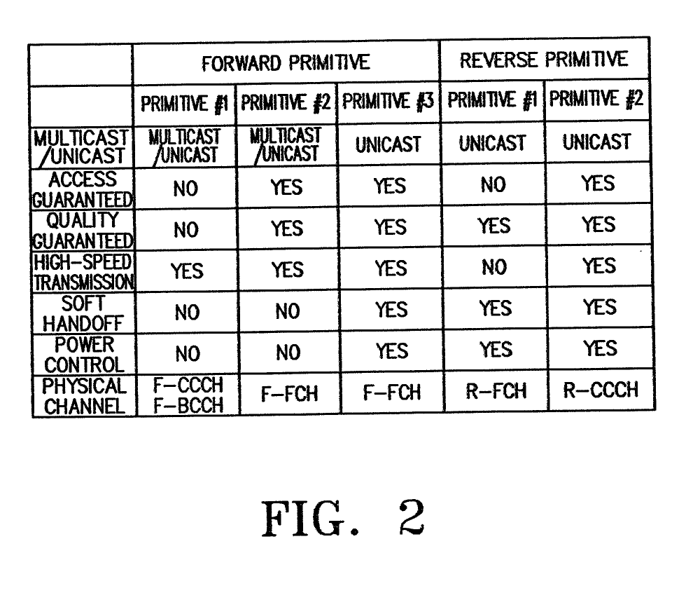

FIG. 2 shows a format of the service primitive information stored in the base station according to an embodiment of the present invention. Referring to FIG. 2, a forward primitive #1 defines a primitive for a service class capable of supporting both the multicast and the unicast as well as high-speed transmission, but neither fully guarantees successful access and service quality (QoS) nor provides soft handoff and power control. The radio channels F-CCCH and F-BCCH can be used to provide the service class defined by the forward primitive #1. A forward primitive #2 defines a primitive for a service class capable of supporting the multicast, the unicast, and the high-speed transmission, and guarantees successful access or the service quality, but does not provide soft handoff and power control. The radio channel F-FCH is used for the service class of the forward primitive #2. Further, a forward primitive #3 defines a primitive for a service class capable of supporting only the unicast and high-speed transmission, guarantees successful access and the service quality, and provides soft handoff and power control. The radio channel F-FCH is used for the service class of the forward primitive #3.

A reverse primitive #1 defines a primitive for a service class capable of supporting only the unicast, and incapable of supporting high-speed transmission, does not guarantee successful access, guarantees the service quality, and further provides soft handoff and power control. The radio channel R-FCH is used for the service class of the reverse primitive #1. A reverse primitive #2 defines a primitive for a service class capable of supporting only the unicast and high-speed transmission, and not only guarantees successful access and the service quality, but also provides soft handoff and power control. The radio channel R-CCCH is used for the service class of the reverse primitive #2.

Structures of the radio channels for supporting the forward and reverse primitives will now be described. The F-FCH channel used by the forward primitive #3 supports soft and softer handoffs in accordance with the IS-2000 standard as in the CDMA-2000 system, and provides power control. The base station assigns the F-FCH channel in compliance with a procedure prescribed under the IS-2000 standard. The F-FCH channel used by the forward primitive #2 supports the handoff, but when a plurality of mobile terminals simultaneously perform a handoff operation during the multicast, overload on the radio channel may be often caused by undue signaling, so the base stations usually are designed to limit the number of mobile terminals capable of simultaneously performing the handoff. Furthermore, power control is not carried out for message broadcasting to the entire cell, since the plurality of mobile terminals are operating on the same channel F-FCH. In the case where the forward primitive #2 is used for a group call, it is necessary for the base station to assign the F-FCH channel to the plurality of mobile terminals efficiently. Accordingly, the base station is designed to assign the same Walsh code corresponding to the F-FCH channel to the plurality of mobile terminals belonging to the same group within its cell.

The F-CCCH channel used by the forward primitive #1 is adapted to group a few adjacent cells on the basis of a given cell within which one mobile terminal is located, thereby supporting a limited handoff within the grouped cells only and providing no power control. Further, the base station assigns the F-CCH channel in a group in order to support the group call, wherein the maximum number of groups supportable in one cell may be limited.

Likewise, the F-BCCH channel used by the forward primitive #1 is adapted to group a few adjacent cells on the basis of a given cell within which one mobile terminal is located, thereby supporting a limited handoff within the grouped cells and providing no power control. Further, the base station assigns the F-BCH channel in a group in order to support the group call, wherein the maximum number of groups supportable in one cell may be limited.

Further, the R-FCH channel used by the reverse primitive #1 is adapted to support soft and softer handoffs in accordance with the IS-2000 standard as in the CDMA 2000 system, wherein a number of supportable channels and a handoff method may depend on an association with the forward channels. The R-FCH channel provides power control, and the base station assigns the R-FCH channel in compliance with the procedure prescribed under the IS-2000 standard.

Furthermore, the R-CCCH channel used by the reverse primitive #2 is adapted to support a limited handoff operation since the number of supportable channels and the handoff method may depend on an association with forward channels. Here, as the reverse primitive #2 supports unicast only, power control is performed using the CPCCH channel, in which, for example, the power control is carried out for 24 channels at 800 Hz, for 48 channels at 400 Hz, and for 96 channels at 200 Hz, respectively. The base station also assigns the R-CCCH channel in accordance with the procedure prescribed in the IS-2000 standard.

As described above, the base station may be adapted to make a choice of a preferred combination of suitable primitives and channels according to the service class of a packet call service. An example of the proposed combinations of the service classes and their corresponding primitives is shown in the Table 1 below, wherein the service primitives referred to are those set forth in the example of FIG. 2.

TABLE 1

| Service Class | Channel | Primitive | Quality of Service |
|---|---|---|---|
| Group Call Type 1 | F-CCCH/ | F-Primitive #1 | Not guaranteed |
| | BCCH | | |
| | R-CCCH | R-Primitive #1 | |
| Group Call Type 2 | F-FCH | F-Primitive #2 | Good |
| | R-CCCH/ | R-Primitive #1/2 | |
| | FCH | | |
| Private Call Type 1 | F-FCH | F-Primitive #3 | Good |
| | R-FCH | R-Primitive #2 | |
| Private Call Type 2 | F-CCCH | F-Primitive #1 | Not guaranteed |
| | R-CCCH | R-Primitive #1 | |

Group call type 1 of the service class in Table 1 is an interactive call service served within a predetermined user group, and is capable of the multicast and half duplex communication, but not guaranteeing the quality of service (QoS). For supporting group call type 1, a channel F-CCCH or F-BCCH is used for the forward primitive #1 and a channel R-CCCH is used for the reverse primitive #1. The group call type 2 of service class supports the multicast within a predetermined user group, and is capable of semi-half-duplex communication and guarantees a good quality of service, wherein the semi-half-duplex communication designates a communication system which continuously uses a channel in the forward direction, and when required intermittently uses a channel in the reverse direction. For supporting the group call type 2, a channel F-FCH is used for the forward primitive #2 and a channel R-CCCH or R-FCH is used for the reverse primitive #1 or #2.

The private call type 1 service class serves as an interactive call service providing its users with a 1:1 communication relationship within a predetermined user group, capable of full duplex communication, as well as guaranteeing the quality of service and success of access. For supporting this private call type 1, a channel F-FCH is used for the forward primitive #3 and a channel R-FCH is used for the reverse primitive #2. The private call type 2 service class is an interactive call service providing its users with a 1:1 communication relationship within a predetermined user group, and is capable of semi-half duplex communication, as well as guaranteeing the high-quality call service and a quick call delivery time, but does not ensure a success of access. For supporting this private call type 2, a channel F-CCCH is used for the forward primitive #1 and the channel R-CCCH is used for the reverse primitive #1.

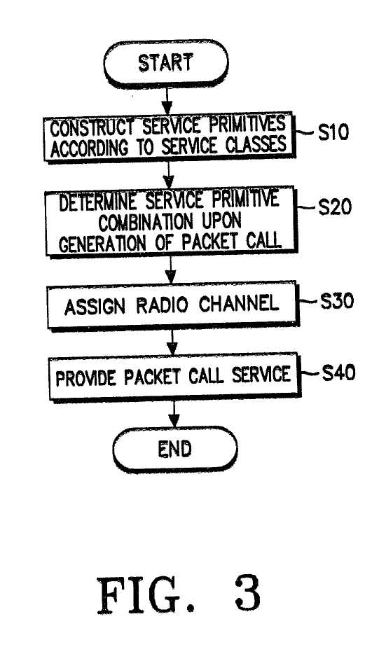

Hereinafter, a procedure for providing the packet call service using the service primitives mentioned above will be described. FIG. 3 illustrates an operation performed in the base station 11 (or 12) for providing a packet call service according to the present invention. The base station constructs in step S10 a set of forward and reverse primitives including the information about assignment of forward and reverse radio channels corresponding to the service class predetermined by the user. The information about the constructed service primitives is associated together with the predetermined service class and then stored in a service primitive database of the base station. The forward and reverse primitives constructed in step S10 are shown by example in FIG. 2. Next, the procedure proceeds to step S20.

In step S20, once a packet voice call for a mobile terminal is generated, the base station refers to the service primitive database and then determines the service primitive combination corresponding to the service class of the packet voice call. The packet call referred to in the present invention is defined as a call in a mobile communication network originating from a mobile terminal or terminating at the mobile terminal. The present invention is generally not applicable to an IP terminal such as a personal computer with a speaker and a microphone that supports an VoIP function in a packet call communication, since the personal computer is usually wire-connected to an IP network, and therefore no radio channel is required.

For example, if a user of a mobile terminal intends to send a group call type 1 to another party's mobile terminal, then the user should operate his own mobile terminal complying to a predetermined procedure to enter the service class information representing the group call type 1. Then, the mobile terminal transmits an origination request message, including the service class information, to the IP network via the base station and the access gateway. The call agent of the IP network connects a channel for delivery of a packet call via IP routing and then transmits the service class information to the base station of an originating (calling) mobile terminal and the other base station of a destination (called) mobile terminal. Each base station then searches its own service primitive database constructed in step S10 to determine the service primitive combination corresponding to the service class information.

In step S30, the base station assigns a radio channel corresponding to the determined service primitive combination to a mobile terminal. For example, provided that the service class selected by the user is the group call type 1 and a combination of the forward primitive #1 and the reverse primitive #1 has been determined accordingly, the radio channel assigned will be F-CCCH and R-CCCH as shown in Table 1. That is to say, the base station assigns the channel F-CCCH to a mobile terminal and then informs a next mobile terminal of the assignment. Then, the mobile terminal assigns the channel R-CCCH.

In step S40, the base station uses the assigned radio channel to provide the mobile terminal with a packet voice call service. For example, if the assigned radio channels should be F-CCCH and R-CCCH, then the group call type 1 of packet call service could be rendered with multicast and half-duplex communication but without guaranteeing of service quality.

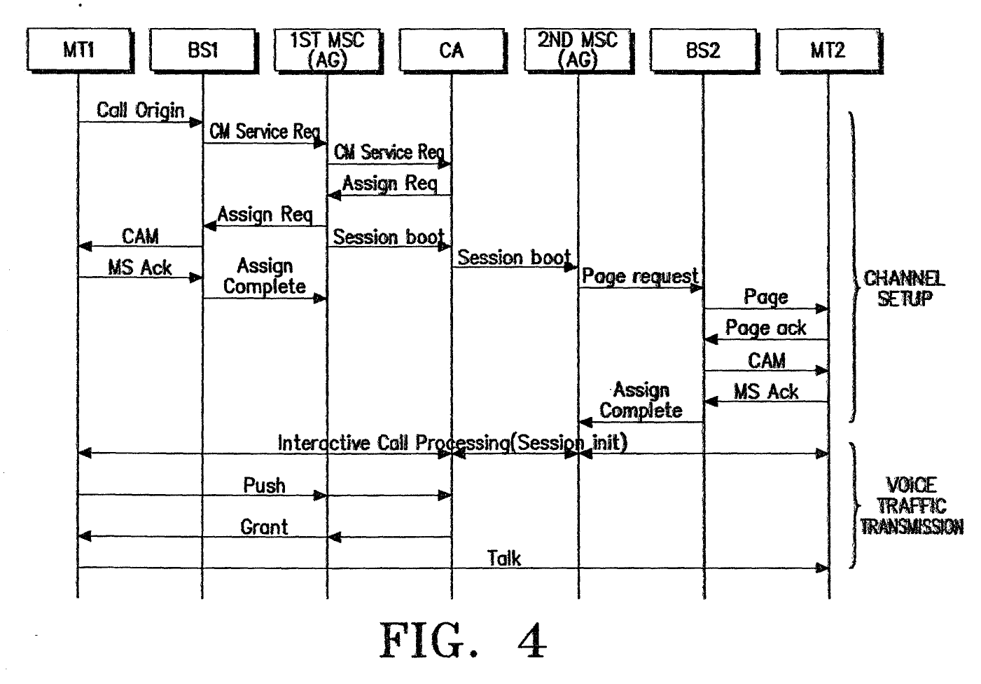

FIG. 4 is a schematic diagram illustrating a sequence of call flow for private call type 1 or group call type 2 according to one embodiment of the present invention. Referring now to FIG. 4, a mobile terminal and a base station communicate with each other certain messages prescribed under the CDMA-2000 standard to assign and maintain radio channels (F-FCH, R-CCCH/R-FCH) for a telephone call. After an elapse of a given amount of time, they control delivery of voice traffic, if any, via the assigned radio channel, guaranteeing assignment and maintenance of a given channel.

A first mobile terminal (MT1) transmits a ‘Call Origin’ message to a first base station (BS1) to request a packet call, wherein the ‘Call Origin’ message includes service class information of the packet call input by a user, for example, information as to whether the call is either a group call or a private call, and its type information. The first base station transmits ‘CM Service Req’ message to a first mobile switching center (MSC) to inform of a request of a packet call. The CM (Connection Management) service request message refers to a message for requesting a call setup on the interface between the BSC and the MSC and it requests assignment for a traffic channel between the BSC and the MSC. Here, provided that the first MSC has been constructed to provide a specific function of gateway access, the first MSC requests from a call agent (CA) a service and then receives a response ‘Assign Req’ from the call agent. The first MSC then transmits the “Assign Req” message to the first base station. Thereafter, the first base station uses the service class information to determine a service primitive combination corresponding thereto, and it assigns a radio channel to the first mobile terminal in accordance with the determined service primitive. The first base station then transmits a ‘Channel Assignment Message (CAM)’ to the first mobile terminal and informing it of assignment of a radio channel. Upon receipt of the CAM, the first mobile terminal transmits are “MS Ack” message to the first base station acknowledging receipt of the CAM. Once the ‘MS Ack’ message has been received from the first terminal, the first base station transmits ‘Assign Complete’ message to the first MSC.

In the meantime, the first MSC transmits a ‘Session Boot’ message to a second MSC at a destination end (called party) via the call agent to assign a session. The second MSC transmits a ‘Page Request’ message to a second base station (BS2), wherein the ‘Page Request’ message includes radio channel assignment information for a second mobile terminal (MT2) at a destination end. Then, the second base station transmits a ‘Page’ message to the second mobile terminal and receives a ‘Page Ack’ message as a response. The second base station also assigns a radio channel for the second terminal and transmits the CAM message to the second mobile terminal. The second mobile then transmits an “MS Ack” to the second base station, acknowledging receipt of the ‘CAM’. Once the ‘MS Ack’ message has been received from the second terminal, the second base station transmits an ‘Assign Complete’ message to the second MSC.

As described above, the first and second mobile terminals, after assignment of the radio channels, performs an interactive call processing operation, so that an initialization of call processing protocol, i.e., ‘Real Time Protocol (RTP)’, for a voice call is accomplished. Once a protocol session has been initialized and any voice traffic has occurred by a push-to-talk function, then the voice traffic is communicated through the assigned radio channel.

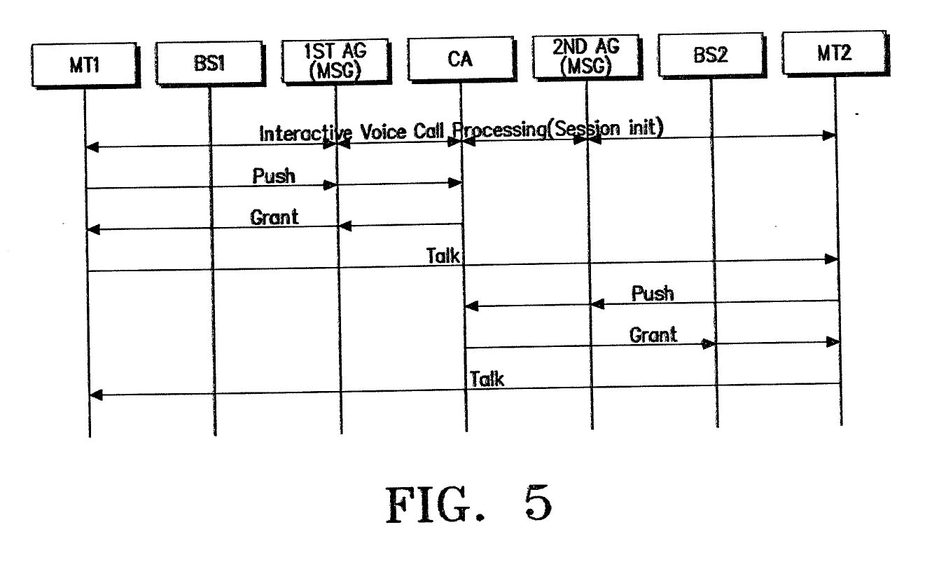

FIG. 5 is a schematic diagram illustrating a sequence of call flow for private call type 2 or group call type 1 according to another embodiment of the present invention. As shown in FIG. 5, a mobile terminal and a base station do not separately assign a specified channel for a voice traffic, but use a common channel (F-CCCH/F-BCCH, R-CCCH) for communication. That is to say, when an initialization of protocol session is carried out by an interactive voice call processing procedure, the originating base station BS1 and destination base station BS2 receive service class information from a call agent to determine a corresponding service primitive combination. Thereafter, once any voice traffic has occurred by the push-to-talk, the base stations assign radio channels on basis of the service primitive combination and deliver the voice traffic. Since group call type 1 or private call type 2 does not assign any dedicated traffic channel between the mobile terminal and the base station for transmission of traffic data, it is not guaranteed assignment and maintenance of a channel. However, it could transmit messages to wider area very efficiently.

As apparent form the foregoing detailed description of a preferred embodiment of the present invention, the method of controlling a packet call service according to the present invention can not only provide a user with a wider variety of call services such as an ‘interactive’ call by means of utilizing a set of service primitive definitions and combinations in the CDMA 2000 system, but also efficiently provides the user with additional types of call services in compliance with the user's needs. Further, in view of an entire mobile communication system, the invention could achieve more efficient and economic application of radio resources owing to the use of a common channel and a radio channel of semi-duplex or semi-half duplex communication.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method of providing a packet call service via an Internet Protocol (IP) based network in a wireless mobile communication system, comprising the steps of:
constructing a set of service primitive information including radio channel assignment information in accordance with at least one service class for the packet call service;
determining a service primitive combination according to a service class of a packet call based on the constructed service primitive information, if a packet call for at least one mobile terminal is generated;
assigning to the at least one mobile terminal a radio channel corresponding to the determined service primitive combination; and
providing the at least one mobile terminal with the packet call service by using the assigned radio channel.

2. The method of claim 1, wherein the service primitive combination is determined on the basis of service class information of the packet call received from the IP network.

3. The method of claim 2, wherein the service class information of the packet call is input by a user of the at least one mobile terminal.

4. The method of claim 1, wherein the service primitive information includes radio channel assignment information for an interactive call.

5. The method of claim 4, wherein the service primitive information, comprises:
at least one forward primitive, selected from the following:
a first forward primitive including channel assignment information for a given channel ‘F-CCCH’ or ‘F-BCCH, having features of multicast and unicast and high-speed transmission, but with its access and quality factors not guaranteed, and further not providing for soft handoff or power control therefor;
a second forward primitive including channel assignment information for a given channel ‘F-FCH’, having features of multicast and unicast and high-speed transmission, with its access and quality factors guaranteed, and further not providing for soft handoff or power control therefor; and
a third forward primitive including channel assignment information for a given channel ‘F-FCH’, having features of unicast and a high-speed transmission, but with its access and quality factors guaranteed, and further providing for soft handoff and power control therefor; and
at least one reverse primitive, selected from the following:
a first reverse primitive including channel assignment information for a given channel ‘R-FCH’, having a feature of unicast, but without high-speed transmission being supported, and without access and quality factors guaranteed, and further providing for soft handoff and power control therefor; and
a second reverse primitive including channel assignment information for a given channel ‘R-CCCH’, having features of unicast and a high-speed transmission supported, and with the access and quality factors guaranteed, and further providing for soft handoff and power control therefor.

6. The method of claim 5, wherein when a group call service is provided to a plurality of mobile terminals by using the channel ‘F-FCH’ according to the second forward primitive, the a number of mobile terminals simultaneously capable of carrying out a handoff is limited.

7. The method of claim 5, wherein when a group call service is provided to a plurality of mobile terminals by using the channel ‘F-FCH’ according to the second forward primitive, no power control is substantially performed.

8. The method of claim 5, wherein when a group call service is provided to a plurality of mobile terminals by using the channel ‘F-FCH’ according to the second forward primitive, an identical Walsh code corresponding to the channel ‘F-FCH’ is assigned to the plurality of mobile terminals.

9. The method of claim 5, wherein when one of a group call and a private call service is provided to at least one mobile terminal by using the channel ‘F-CCCH’ or ‘F-BCCH’ according to the first forward primitive, a plurality of cells preassigned to said at least one mobile terminal are grouped together in an area in which a limited handoff is provided.

10. The method of claim 5, wherein when one of a group call and a private call service is provided to at least one mobile terminal by using the channel ‘R-CCCH’ according to the second reverse primitive, power control is provided using a Common Power Control Channel (CPCCH).

11. A method of providing a packet call service via an Internet Protocol (IP) based network in a wireless mobile communication system, comprising the steps of:
upon request of a packet call to the IP network, transmitting from the IP network service class information for the packet call to a base station in the wireless mobile communication system;
analyzing the service class information in the base station, and if the packet call is an interactive group call serving a semi half-duplex communication, determining a service primitive combination corresponding to the group call based on predefined service primitive information;
assigning to a plurality of group call mobile terminals one of a forward channel ‘F-CCCH’ and ‘F-BCCH’, and a reverse channel ‘R-CCCH’ according to the determined service primitive combination; and
providing said plurality of group call mobile terminals with an interactive group call service by using the assigned radio channels.

12. A method of providing a packet call service via an Internet Protocol (IP) based network in a wireless mobile communication system, comprising the steps of:
upon request of a packet call to the IP network, transmitting from the IP network service class information for the packet call to a base station in the wireless mobile communication system;
analyzing the service class information in the base station, and if the packet call is an interactive group call serving a full-duplex communication, determining a service primitive combination corresponding to the group call based on predefined service primitive information constructed in advance;
assigning to a plurality of group call mobile terminals a given forward channel ‘F-FCH’, and one of a reverse channel ‘R-CCCH’ and ‘R-FCH’ according to the determined service primitive combination; and
providing said plurality of group call mobile terminals with an interactive group call service by using the assigned radio channels.

13. The method of claim 12, wherein when providing the interactive group call service, the a number of mobile terminals simultaneously capable of carrying out a handoff is limited.

14. The method of claim 12, wherein when providing the interactive group call service, no power control is substantially performed.

15. The method of claim 12, wherein when assigning the channel ‘F-FCH’, an identical Walsh code corresponding to the channel ‘F-FCH’ is assigned to the plurality of group call mobile terminals.

16. The method of claim 12, wherein when providing the interactive group call service, power control is provided using a Common Power Control Channel (CPCCH).

17. A method of providing a packet call service via an Internet Protocol (IP) based network in a wireless mobile communication system, comprising the steps of:
upon request of a packet call to the IP network, transmitting from the IP network service class information for the packet call to a base station in the wireless mobile communication system;
analyzing the service class information in the base station, and if the packet call is an interactive private call serving a full-duplex communication, determining a service primitive combination corresponding to the private call based on predefined service primitive information;
assigning to a private call mobile terminal a given forward channel ‘F-FCH’ and a given reverse channel ‘R-FCH’ according to the determined service primitive combination; and
providing said private call mobile terminals with an interactive private call service by using the assigned radio channels.

18. A method of providing a packet call service via an Internet Protocol (IP) based network in a wireless mobile communication system, comprising the steps of:
upon request of a packet call to the IP network, transmitting from the IP network service class information for the packet call to a base station in the wireless mobile communication system;
analyzing the service class information in the base station, and if the packet call is an interactive private call serving a semi-half duplex communication, determining a service primitive combination corresponding to the private call based on predefined service primitive information;
assigning to a private call mobile terminal a given forward channel ‘F-CCCH’ and a given reverse channel ‘R-CCCH’ according to the determined service primitive combination; and
providing said private call mobile terminal with an interactive private call service by using the assigned radio channels
